(19) United States
(12) Patent Application Publication
(10) Pub. No.: US 2025/0360875 A1
(43) Pub. Date: Nov. 27, 2025

(54) Baseplate, Mirror Foot and Mounting Arrangement for Attaching an Inner Mirror for a Vehicle

(71) Applicant: Bayerische Motoren Werke Aktiengesellschaft, Muenchen (DE)

(72) Inventors: Bernd KRONOWETTER, Mitterfelden (DE); Paul ROSENKRANZ, Muenchen (DE)

(21) Appl. No.: 18/874,874

(22) PCT Filed: Aug. 8, 2023
(86) PCT No.: PCT/EP2023/071945

§ 371 Date: Dec. 13, 2024

(30) Foreign Application Priority Data
Aug. 24, 2022 (DE) 10 2022 121 391.9

(51) Int. Cl. B60R 1/04; B60R 1/12

(52) U.S. Cl. CPC B60R 1/04; B60R 1/12; B60R 2001/1223

(57) ABSTRACT

For the purpose of providing a low-vibration and space-saving baseplate for arranging on a windscreen of a vehicle and for receiving a mirror base for an inner mirror, the baseplate having a baseplate plane, it is provided that at least six resistance surfaces are arranged on the baseplate plane. In each case two resistance surfaces are at least partially arranged in a common resistance plane, as a result of which at least three resistance planes are formed. Each of the resistance planes is oriented with respect to the baseplate plane in such a manner that it intersects the baseplate plane in a straight line, as a result of which at least three straight lines are formed in the baseplate plane. The straight lines among one another at least in pairs have an intersecting point with an acute intersecting angle, as a result of which at least three acute intersecting angles a are formed. The intersecting point is arranged between the associated resistance surfaces of the intersecting straight lines, and the acute intersecting angles are identical.

### BACKGROUND AND SUMMARY

The present invention relates to a base plate, a mirror foot, and a mounting arrangement for attaching an interior mirror to a vehicle.

In vehicle construction, an interior mirror is typically attached to a windshield inside a vehicle. A mounting arrangement known in the art in this case comprises a base plate that is attached to the windshield. A mirror foot is mounted on the base plate, wherein the mirror foot is screwed onto the base plate during mounting. In the final assembled position, the base plate and the mirror foot lie against one another and are held together by a torsion spring. The interior mirror is finally arranged on the mirror foot.

For example, it is known from DE 21 2018 000 374 U1 that four locating grooves of a holder engage with four locating mechanisms on a windshield button, wherein the holder and the windshield button are held together by means of a fastening clip. The windshield button is also provided to accommodate a sensor in this case.

Furthermore, DE 11 2019 000 611 T5 discloses that five fitting approaches from five 20 projections of a support bracket and fitting grooves in a support surface of a mounting base rest against one another and are pressed against one another by means of a pretensioning force of legs of a support bracket leaf spring. Five contact support sections are thereby created. The arrangement of a sensor is also provided between the support bracket and the mounting base.

However, a disadvantage of the mounting arrangements known in the art is that they have a complex structure and therefore require a large amount of space. In addition, unwanted vibrations may occur in the mounting arrangements during vehicle operation which cannot be prevented by the mounting arrangements known in the art.

The present invention is therefore based on the object of providing a compact and vibration-resistant base plate and a corresponding mirror foot for attaching an interior mirror to a vehicle, and also a corresponding mounting arrangement.

The object according to the invention is achieved by the features of the independent claim(s). Advantageous developments of the invention emerge from the dependent claims.

The invention relates to a base plate designed to be arranged on a windshield of a vehicle and to accommodate a mirror base (foot) for an interior mirror, wherein the base plate has a base plate plane. According to the invention, at least six resistance surfaces are arranged on the base plate plane, wherein two resistance surfaces in each case are arranged at least in part on a common resistance plane, as a result of which at least three resistance planes are formed, wherein each of the resistance planes is aligned with respect to the base plate plane in such a manner that it intersects the base plate plane in a straight line, forming at least three straight lines on the base plate plane, wherein the straight lines have one point of intersection with one another at least in pairs at an acute angle of intersection, as a result of which at least three acute angles of intersection are formed, the point of intersection is arranged between the associated resistance surfaces of the intersecting straight lines, and the acute angles of intersection are equal.

The fact that the acute angles of intersection are equal means that the base plate allows for a uniformly distributed transfer of forces that occur during vehicle operation, as a result of which vibrations are minimized. These forces can therefore be symmetrically absorbed or transmitted by the base plate. In addition, the planar design of the resistance surfaces allows them to absorb or transmit forces particularly efficiently, and they can be designed to save space compared with interlocking elements. In this case, the term “equal acute angles of intersection” generally means that the acute angles of intersection are substantially equal and only differ within a tolerance range of ±3°.

Six resistance surfaces are preferably arranged on the base plate plane in this case and the acute angles of intersection are each 60°. With six resistance surfaces and acute angles of 60°, the forces are absorbed particularly well. A resistance surface corresponds to half a support point in a static system in this case, which is in turn completely defined by three full support points. When there are six resistance surfaces, over-definition is therefore avoided, saving further space. In general terms, within the meaning of mechanics, a resistance surface can be regarded as half a support point. Three support points are sufficient to define a stable orientation in space.

In a preferred embodiment, two resistance surfaces are arranged at least in part in a common resistance plane such that, when the base plate is in the installed state in the vehicle, the resistance surfaces are set up to absorb an impact force resulting from a collision in the X-direction of the vehicle. The impact force may, for example, be caused by the forwards-accelerating head of a vehicle occupant. In this way, the impact force in the X-direction of the vehicle can be absorbed particularly well by the base plate up to a certain threshold value. The two resistance surfaces are arranged in such a manner in this case that the mirror base becomes detached from the base plate when the impact force exceeds the threshold value, as a result of which head injuries can be avoided. As a general rule, impact forces are defined by the regulation FMVSS 571.111.

In order to limit the detachment of the mirror base from the base plate, the mirror base is preferably connected to the base plate via a tether. In one embodiment, the base plate therefore has a side wall, wherein a through-hole for receiving a clip for the tether is arranged in the side wall. The clip is connected to the tether in this case and engages in the through-hole.

In one embodiment, an engagement region for the engagement of a torsion spring of planar design is formed on the side wall. This allows for a mirror base to be fastened to the base plate by means of the torsion spring in an advantageous manner.

Particularly preferably, the engagement region comprises fixing elements projecting from the side wall for the engagement of the torsion spring and at least two recesses, wherein each recess has a pre-fixing rib on the side wall for engaging with the torsion spring. The mirror base can be pre-fixed to the pre-fixing ribs during assembly by means of the torsion spring before it is rotated into its final mounting position. This provides for easier mounting with increased security, as the mirror base can be fastened to the base plate beforehand in a first hand position and conveniently rotated into the final mounting position in a second hand position, wherein the second hand position is better suited to rotating. This prevents the mirror base from falling when changing from the first to the second hand position.

In all embodiments, it is preferred that the angle between the base plate plane and the respective resistance plane is smaller than 90° and therefore preferably lies in the range of 25° to 45°, particularly preferably in the range of 30° to 45°. With regard to impact forces in the X-, Y-, or Z-direction of the vehicle, threshold values for detaching the mirror base from the base plate can thereby be set particularly advantageously.

The invention further relates to a mirror base for connecting to a base plate and for arranging an interior mirror on a windshield of a motor vehicle, wherein the mirror base has a mirror base plane. According to the invention, at least six fixing surfaces are arranged on the mirror base plane, wherein two fixing surfaces in each case are arranged at least in part on a common fixing plane, as a result of which at least three fixing planes are formed, wherein each of the fixing planes is aligned with respect to the mirror base plane in such a manner that it intersects the mirror base plane in a straight line, forming at least three straight lines on the mirror base plane, wherein the straight lines have one point of intersection with one another at least in pairs at an acute angle of intersection, as a result of which at least three acute angles of intersection are formed, the point of intersection is arranged between the associated resistance surfaces of the intersecting straight lines, and the acute angles are equal.

The fact that the acute angles of intersection are equal means that the mirror base allows for a uniformly distributed transfer of forces that occur during vehicle operation, as a result of which vibrations are minimized. These forces can therefore be symmetrically absorbed or transmitted by the mirror base. In addition, the planar design of the fixing surfaces allows them to absorb or transmit forces particularly efficiently, and they can be designed to save space compared with interlocking elements. In this case, the term “equal acute angles of intersection” generally means that the acute angles of intersection are substantially equal and only differ within a tolerance range of ±3°.

The invention also relates to a mounting arrangement for attaching an interior mirror to a vehicle, comprising a base plate according to one of the preceding embodiments, and a mirror base according to the preceding embodiment, wherein in the final mounted state, the base plate and the mirror base are connected to one another in such a manner that a resistance surface and a fixing surface lie adjacent to one another.

The fact that the acute angles of intersection are equal for both the base plate and the mirror base means that the mounting arrangement allows for a uniformly distributed transfer of forces that occur during vehicle operation, as a result of which vibrations are minimized. These forces can therefore be symmetrically absorbed or transmitted by the pairs of resistance surfaces and fixing surfaces lying adjacent to one another in a plane. Moreover, the planar design of the resistance surfaces and fixing surfaces allows the forces that occur to be absorbed or transmitted particularly efficiently, and they can be designed to save space compared with interlocking elements.

In a preferred embodiment, the mounting arrangement comprises a sensor for positioning on a windshield for a vehicle, wherein in the final mounted state, the sensor and the base plate connected to the mirror base are arranged at different locations, preferably alongside one another, on the windshield. Since the base plate according to the invention, as described above, is designed to be particularly space-saving, the base plate is advantageously arranged next to a sensor on the windshield, allowing for a flatter design of the base plate and sensor in the interior. According to the invention, the sensor is not therefore arranged within the base plate.

The mounting arrangement may preferably also comprise a windshield of a vehicle. Furthermore, a vehicle that has a base plate according to one of the preceding embodiments, a mirror base according to the preceding embodiment, or a mounting arrangement according to one of the preceding embodiments is provided.

Embodiments of the invention are described below with reference to the figures.

### BRIEF DESCRIPTION OF THE DRAWINGS

FIG. 1 is a schematic perspective view of an embodiment of a base plate according to the invention;

FIG. 2 is a schematic perspective view of an embodiment of a mirror base according to the invention;

FIG. 3 is a schematic side view of an embodiment of a mounting arrangement according to the invention;

FIG. 4 is a schematic perspective view of an embodiment of a base plate according to the invention with a torsion spring in a pre-fixing position; and

FIG. 5 is a schematic perspective view of an embodiment of a base plate according to the invention with a torsion spring in a mounted final state.

### DETAILED DESCRIPTION OF THE DRAWINGS

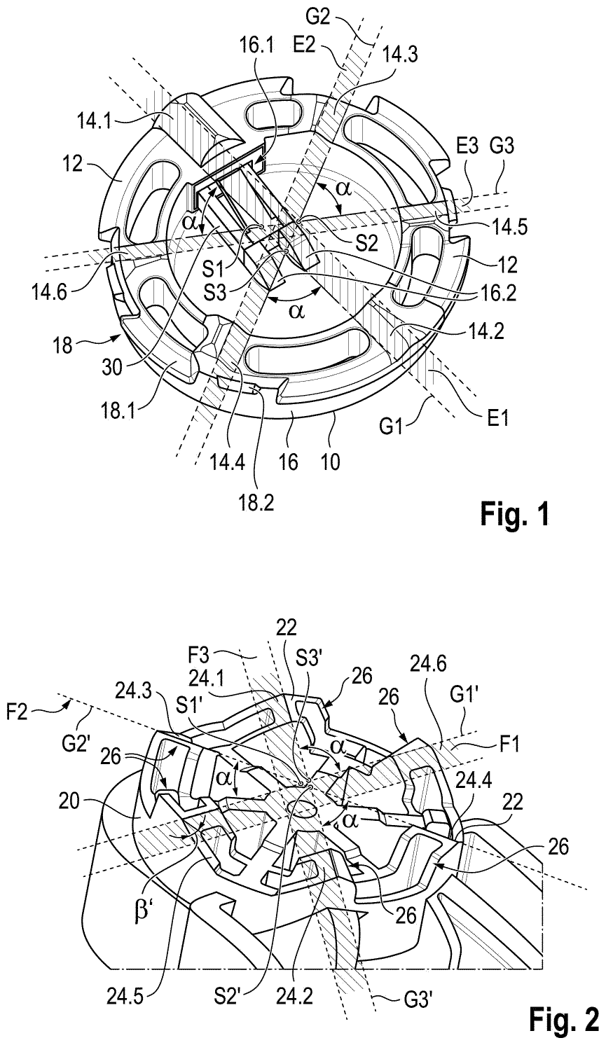

FIG. 1 shows a schematic perspective view of an embodiment of a base plate 10 for arranging on a windshield of a vehicle and for accommodating a mirror base 20 from FIG. 2 for an interior mirror. The base plate 10 is preferably designed in a circular shape.

The base plate 10 in this case preferably extends at least in part in a base plate plane 12. As shown in FIG. 1, the base plate plane 12 can be formed by a surface of the base plate. However, it is also contemplated that the base plate plane 12 is only defined by an abstract plane. Parts of the base plate 10 preferably extend in this plane or at least intersect it.

Six resistance surfaces 14.1-14.6 are arranged on the base plate plane 12. The resistance surfaces 14.1 and 14.2 in this case are arranged as a first pair at least in part on a common resistance plane E1. For example, edge areas of the resistance surfaces 14.1 and 14.2 can also extend beyond the plane E1.

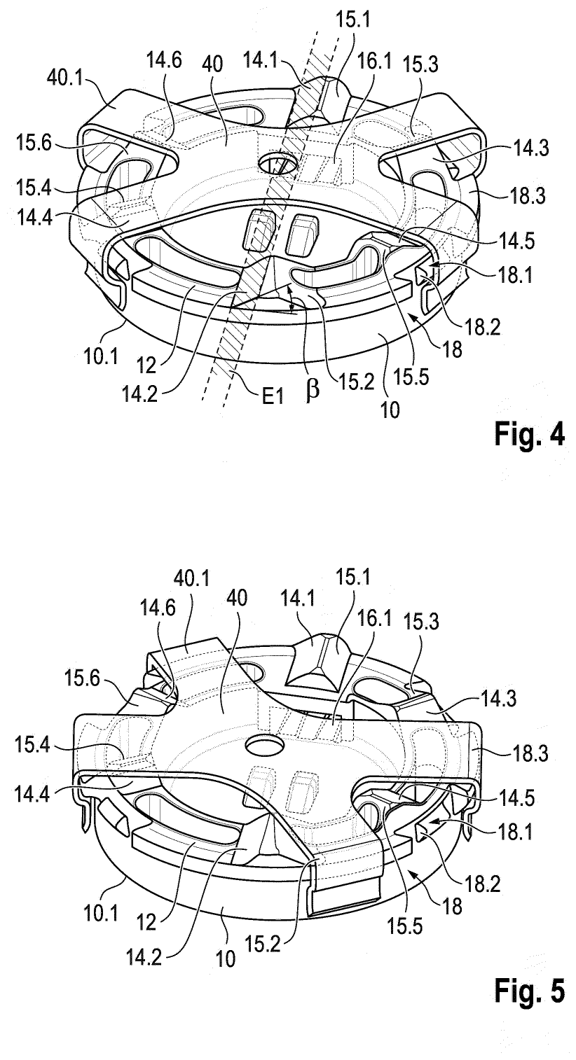

As can be seen in FIG. 4, the resistance plane E1 is arranged at an angle β to the base plate plane 12, and the plane E1 therefore intersects the base plate plane 12 in a straight line G1. The angle β is not drawn in FIG. 1 for reasons of greater clarity. The angle β is preferably less than 90° and preferably lies in the range of 25° to 45°, particularly preferably in the range of 30° to 45°.

In the same manner as the first pair, the second pair of resistance surfaces 14.3 and 14.4, and also the third pair of resistance surfaces 14.5 and 14.6, is arranged in planes E2 and E3, respectively, at an angle β to the base plate plane 12, forming the straight lines G2 and G3. The chosen angle β in this case may be the same or different for each plane E1, E2, and E3.

The resistance surfaces 14.1-14.6 in this case are arranged on the base plate plane 12 in such a manner that the resulting straight lines G1-G3 have a point of intersection S1-S3 with one another at least in pairs at an acute angle of intersection α. For example, the point of intersection S1 is formed by the intersecting straight lines G1 and G3 and is arranged between the resistance surfaces 14.1 and 14.2, and also 14.5 and 14.6, in this case. Furthermore, the point of intersection S2 is formed by the intersecting straight lines G2 and G3, for example, and is arranged between the resistance surfaces 14.3 and 14.4, and also 14.5 and 14.6, in this case. Finally, the point of intersection S3 is formed by the intersecting straight lines G1 and G2, for example, and is arranged between the resistance surfaces 14.1 and 14.2, and also 14.3 and 14.4, in this case.

As can be seen in FIG. 1, this results in three identical acute angles of intersection α between the straight lines G1 and G2, G2 and G3, and G1 and G3. In the preferred case of three pairs of resistance surfaces, the acute angles of intersection α are always 60°.

The identical acute angles of intersection α ensure that a uniformly distributed transfer of forces that occur during vehicle operation across the resistance surfaces 14.1-14.6 of the base plate 10 is guaranteed. Due to their planar design, the resistance surfaces 14.1-14.6 can absorb and transmit the forces occurring particularly efficiently, and they can be designed to save space compared with interlocking elements. Consequently, vibrations during vehicle operation are minimized.

It is also contemplated in this case that the base plate 10 has more than three pairs of resistance surfaces, wherein the resulting acute angles of intersection α are constantly equal, in order to guarantee a symmetrical force distribution. As mentioned earlier, a tolerance range of ±3° is taken into consideration here too.

Moreover, it is also contemplated that the resistance surfaces 14.1-14.6 are arranged in such a manner that the resulting straight lines G1-G3 all intersect at a common point of intersection S (not shown). When the resistance surfaces 14.1-14.6 are arranged in a circular shape, as shown in FIG. 2, the distances between the resistance surfaces 14.1-14.6 on a circumference line increase and this represents an alternative arrangement for uniform force transmission with an identical acute angle of intersection α.

One pair of resistance surfaces is preferably aligned with the X-direction of the vehicle, for example in FIG. 1 this may be the resistance surfaces 14.5 and 14.6.

When the base plate is in the installed state in the vehicle, the resistance surfaces 14.5 and 14.6 are set up to absorb an impact force resulting from a collision in the X-direction of the vehicle. The impact force may, for example, be caused by the forwards-accelerating head of a vehicle occupant hitting the interior mirror. In this way, the impact force in the X-direction of the vehicle can be absorbed particularly well by the base plate 10 up to a certain threshold. The two resistance surfaces 14.5 and 14.6 are arranged in such a manner by selecting the angle β that the mirror base 20 with the interior mirror becomes detached from the base plate 10 if the impact force exceeds the threshold value, as a result of which head injuries can be avoided.

Similarly, the pairs of resistance surfaces 14.1 and 14.2, and also 14.3 and 14.4, can be aligned with the Y-direction of the vehicle, allowing the mirror base 20 with the interior mirror to become detached from the base plate 10 in the same way if impact forces occur in the Y-direction of the vehicle. In this case, forces can act and be absorbed in the XY-plane.

Moreover, it can be seen in FIG. 1 that a through-hole 16.1 is formed in a side wall 16 of the base plate 10. A clip 30 can be inserted through the through-hole 16.1, the movement of which is limited by at least one limiting element 16.2 within the base plate 10. The clip 30 is formed in such a manner that in a locking position, a flexible element of the clip 30 is engaged with the base plate 10 at the limiting element 16.2. A tether is fastened to one end of the clip (not shown), which is in turn fastened to the mirror base 20. In the event of a vehicle collision, the mirror base 20 with the interior mirror becomes detached from the base plate 10 and its movement can be limited by means of the tether.

FIG. 2 shows a schematic perspective view of an embodiment of a mirror base 20, for connecting to the base plate 10 and for arranging an interior mirror on a windshield of a vehicle. The mirror base 20 acts as the counterpart to the base plate 10 and has an arrangement of planes, straight lines, and angles corresponding to the base plate 10.

The mirror base 20 preferably extends at least in part in a mirror base plane 22 in this case. As shown in FIG. 2, the mirror base plane 22 can be formed by a surface of the mirror base 20. However, it is also contemplated that the mirror base plane 22 is only defined by an abstract plane. Parts of the mirror base 20 preferably extend in this plane or at least intersect it.

Six fixing surfaces 24.1-24.6 are arranged on the mirror base plane 22. The fixing surfaces 24.1 and 24.2 in this case are arranged as a first pair at least in part on a common fixing plane F3. For example, edge areas of the fixing surfaces 24.1 and 24.2 can also extend beyond the plane F3.

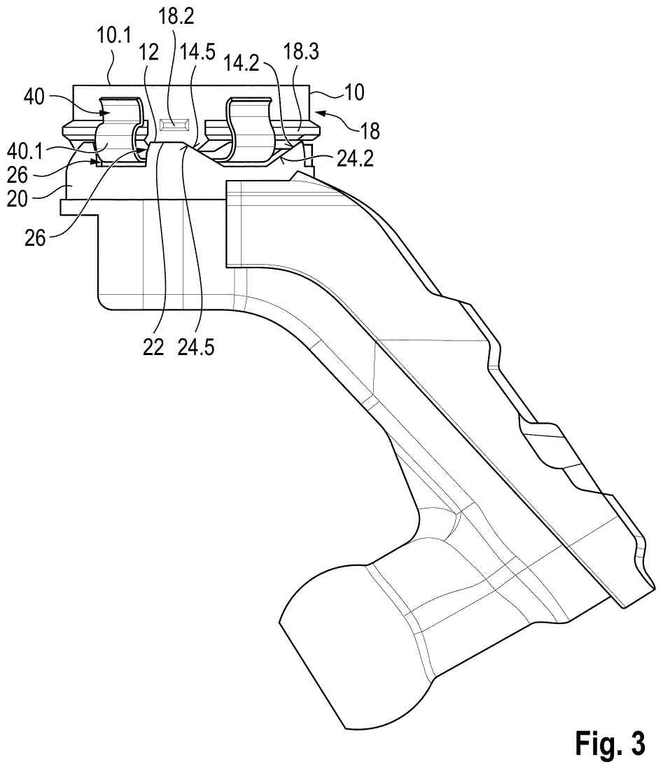

In contrast to the base plate 10, the fixing surfaces 24.1-24.6 in FIG. 2 extend from the mirror base plane 22 towards the rest of the body of the mirror base 20, whereas in the case of the base plate 10 in FIG. 1, the resistance surfaces 14.1-14.6 extend away from the base plate plane 12 from the rest of the body of the base plate 10. In this way, the resistance surfaces 14.1-14.6 can lie against one another with the fixing surfaces 24.1-24.6 in a key-lock principle in the mounted state, as shown in FIG. 3.

As a result of this, all advantageous features of the base plate 10 are also applicable to the mirror base 20 and are transferable thereto.

As further shown in FIG. 2, a fixing plane F1 is arranged by way of example at an angle β′ to the mirror base plane 22 and the plane F1 thereby intersects the mirror base plane 22 along a straight line G1′. The angle β′ is preferably smaller than 90° and preferably lies in the range of 25° to 45°, particularly preferably in the range of 30° to 45°.

In the same manner as the first pair, the second pair of fixing surfaces 24.3 and 24.4, and also the third pair of fixing surfaces 24.5 and 24.6, are arranged in planes F2 and F1 at an angle β′ to the mirror base plane 22 (the angle β′is not shown for these pairs), as a result of which the straight lines G2′ and G3′ are formed. The chosen angle β′ in this case may be the same or different for each plane F1, F2, and F3. Preferably, β′=β is chosen in each case, to enable better mutual alignment of the resistance surfaces 14.1-14.6 with the fixing surfaces 24.1-24.6, as shown in FIG. 3.

The fixing surfaces 24.1-24.6 in this case are arranged on the mirror base plane 22 in such a manner that the resulting straight lines G1′-G3′ have a point of intersection S1′-S3′ with one another at least in pairs at an acute angle of intersection α. The point of intersection S1′ is formed by the intersecting straight lines G1′ and G2′, for example, and is arranged between the fixing surfaces 24.5, 24.6, and 24.3, 24.4. Furthermore, the point of intersection S2′ is formed by the intersecting straight lines G2′ and G3′, for example, and is arranged between the fixing surfaces 24.3, 24.4, and 24.1, 24.2. Finally, the point of intersection S3′ is formed by the intersecting straight lines G1′ and G3′, for example, and is arranged between the fixing surfaces 24.1, 24.2, and 24.5, 24.6, in this case.

As can be seen in FIG. 2, three identical acute angles of intersection α are thereby formed between the straight lines G1′ and G2′, G2′ and G3′, and G1′ and G3′. In the preferred case of three pairs of fixing surfaces, the acute angles of intersection α are always 60°.

The identical acute angles of intersection α ensure that a uniformly distributed transfer of forces that occur during vehicle operation across the fixing surfaces 24.1-24.6 of the mirror base 20 is guaranteed. Due to their planar design, the fixing surfaces 24.1-24.6 can absorb and transmit the forces occurring particularly efficiently, and they can be designed to save space compared with interlocking elements. Consequently, vibrations during vehicle operation are minimized.

It is also contemplated in this case that the mirror base 20 has more than three pairs of fixing surfaces, wherein the resulting acute angles of intersection α are consistently equal, in order to guarantee a symmetrical force distribution. As mentioned earlier, a tolerance range of ±3° is taken into consideration here too.

Moreover, it is also contemplated that the fixing surfaces 24.1-24.6 are arranged in such a manner that the resulting straight lines G1′-G3′ all intersect at a common point of intersection S′ (not shown). When the fixing surfaces 24.1-24.6 are arranged in a circular shape, as shown in FIG. 2, the distances between the fixing surfaces 24.1-24.6 on a circumference line increase and this provides an alternative arrangement for uniform force transmission with an identical acute angle of intersection α.

One pair of fixing surfaces is preferably aligned with the X-direction of the vehicle, for example in FIG. 1 this may be the fixing surfaces 24.5 and 24.6.

When the base plate is in the installed state in the vehicle, the fixing surfaces 24.5 and 24.6 are set up to absorb an impact force resulting from a collision in the X-direction of the vehicle. The impact force may, for example, be caused by the forwards-accelerating head of a vehicle occupant hitting the interior mirror. In this way, the impact force in the X-direction of the vehicle can be absorbed particularly well by the mirror base 20 up to a certain threshold. The two fixing surfaces 24.5 and 24.6 are arranged in such a manner by selecting the angle β′ that the mirror base 20 with the interior mirror becomes detached from the base plate 10 if the impact force exceeds the threshold value, as a result of which head injuries can be avoided.

Similarly, the pairs of fixing surfaces 24.1 and 24.2, and also 24.3 and 24.4, can be aligned with the Y-direction of the vehicle, allowing the mirror base 20 with the interior mirror to become detached from the base plate 10 in the same way if impact forces occur in the Y-direction of the vehicle. In this case, forces can act and be absorbed in the XY-plane.

FIG. 3 shows a schematic side view of an embodiment of a mounting arrangement according to the invention with the base plate 10 from FIG. 1 and the mirror base 20 from FIG. 2. A bottom 10.1 of the base plate 10 is arranged on a windshield of a vehicle in this case. It is contemplated in this case that the diameter of the bottom 10.1 falls within the range of 30 mm to 55 mm, preferably of 40 mm to 55 mm, and particularly 40 mm. This compact design of the base plate 10 is achieved through the arrangement of the resistance surfaces 14.1-14.6 according to the invention.

In general, in the final mounted state, a resistance surface 14 and a fixing surface 24 each lie adjacent to one another. For example, it can be seen in FIG. 3 that the resistance surface 14.5 and the fixing surface 24.5 lie adjacent to one another. In this case, the base plate 10 and the mirror base 20 are held together and pressed against one another by a torsion spring 40. As a general rule, the torsion spring 40 can be arranged on a rotational axis between the base plate 10 and the mirror base 20 in a manner known per se and can, moreover, be initially connected to the mirror base 20.

The torsion spring 40 comprises at least two mutually opposing engagement arms 40.1. One engagement arm 40.1 is set up in this case to engage with an engagement region 18 of the base plate 10 during assembly and in the final mounted state, as explained with reference to FIGS. 4 and 5.

In the mounting arrangement of FIG. 3, a sensor, such as a rain sensor, for example, is particularly preferably provided for arrangement on a windshield for a vehicle (not shown). In the final mounted state in this case, the sensor and the base plate 10 are arranged at different locations, preferably alongside one another on the windshield. Since the sensor is not arranged within but outside the base plate 10 on the windshield, the available space can advantageously be used for the arrangement of the resistance surfaces 14.1-14.6, and need not be reserved for the sensor. This allows for a flatter height or also a smaller diameter for the bottom 10.1 of the base plate.

FIG. 4 shows a schematic perspective view of an embodiment of a base plate 10 with the torsion spring 40 in a pre-fixing position during assembly, wherein the mirror base 20 is not shown for reasons of greater clarity.

In the preferred embodiment in FIG. 4, the torsion spring 40 comprises, for example, four engagement arms 40.1 which each engage with the engagement region 18 of the base plate 10. However, embodiments with a different number of engagement arms 40.1 are also conceivable.

The engagement region 18 is arranged on the side wall 16 of the base plate and has at least two recesses 18.1 in this case which are arranged between fixing elements 18.3 that project from the side wall 16. Moreover, a pre-fixing rib 18.2 is arranged near each recess 18.1. For example, as shown in FIG. 4, the pre-fixing rib 18.2 is arranged between the recess 18.1 and the bottom 10.1 of the base plate 10. The fixing element 18.3 in this case preferably extends further from the side wall 16 than the pre-fixing rib 18.2.

During assembly, in the pre-fixing position, the engagement arm 40.1 engages with the pre-fixing rib 18.2 rather than the fixing element 18.3 due to the recess 18.1. In this way, the mirror base 20 is pre-fixed on the pre-fixing ribs during mounting by means of the torsion spring 40, before it is rotated into its final mounting position.

The base plate 10 and the mirror base 20 can preferably be configured in such a manner that three of the resistance surfaces 14 are directly aligned during assembly and do not create resistance during assembly. The remaining three resistance surfaces 14 are reached by passing over them during assembly, as a result of which a mounting force resistance is defined.

During this, pre-fixing surfaces 26 of the mirror base 20 are each assigned to guide surfaces 15 of the base plate 10 in the pre-fixing position. As can be seen in FIGS. 2 and 3, each pre-fixing surface 26 is opposite one of the fixing surfaces 24.1-24.6, so that the two surfaces form an angle to one another. Accordingly, as can be seen in FIGS. 4 and 5, each guide surface 15 is positioned opposite one of the resistance surfaces 14.1-14.6, so that both surfaces form an angle with one another.

FIG. 5 shows a schematic perspective view of an embodiment of a base plate 10 according to the invention with the torsion spring 40 in a final mounted state, wherein the mirror base 20 is not shown for reasons of greater clarity.

In the transition from the pre-fixing position shown in FIG. 4 to the final mounted state in FIG. 5, one of the pre-fixing surfaces 26 can be rotated from its corresponding guide surface 15 towards the corresponding resistance surface 14.1-14.6 by turning the torsion spring 40, so that in the final mounted state, the corresponding fixing surface 24.1-24.6 lies against the corresponding resistance surface 14.1-14.6 and is fixed thereto by a spring force of the torsion spring 40, as can be seen in FIG. 3.

It is contemplated in principle that three guide surfaces 15 are each passed over by a corresponding pre-fixing surface 26, wherein the mounting force resistance is generated. This is preferably the case for the guide surfaces 15.2, 15.3, and 15.6. In other words, the pre-fixing surface 26 therefore slides over the corresponding guide surface 15 towards the final mounted state, in which the fixing surfaces 24.1-24.6 lie against the corresponding resistance surfaces 14.1-14.6.

Alternatively or in addition, without sliding its pre-fixing surface 26 over a guide surface 15, a corresponding fixing surface 24.1-24.6 can be rotated from the pre-fixing position to the final mounted state towards its corresponding resistance surface 14.1-14.6 during turning, so that they lie against one another and are fixed by the spring force of the torsion spring 40. This is preferably the case with the fixing surfaces 24.1, 24.4, and 24.5.

During this rotational process, an engagement arm 40.1 is also rotated from the pre-fixing rib 18.2 to the corresponding fixing element 18.3 and engages therewith, as a result of which the spring force is generated.

As a general rule, other shapes for the resistance surfaces 14.1-14.6, the guide surfaces 15, the fixing surfaces 24.1-24.2, and the pre-fixing surfaces 26 are also conceivable. In principle, all the aforementioned elements and surfaces are arranged and aligned in terms of their shape, height, and angle in this case, in such a manner that the requirements resulting from corresponding standards, such as FMVSS 571.111 and ECE-R46, for example, are met.

### LIST OF REFERENCE SIGNS

10 base plate
10.1 bottom of the base plate
12 base plate plane
14.1, 14.2 first pair of resistance surfaces
14.3, 14.4 second pair of resistance surfaces
14.5, 14.6 third pair of resistance surfaces
16 side wall
16.1 through-hole
16.2 limiting element
18 engagement region
18.1 recess
18.2 pre-fixing rib
18.3 fixing element
20 mirror base (foot)
22 mirror base plane
24.1, 24.2 first pair of fixing surfaces
24.3, 24.4 second pair of fixing surfaces
24.5, 24.6 third pair of fixing surfaces
26 pre-fixing surface
30 clip
40 torsion spring
40.1 engagement arm
E1 common plane for the first pair of resistance surfaces
E2 common plane for the second pair of resistance surfaces
E3 common plane for the third pair of resistance surfaces
F1 common plane for the first pair of fixing surfaces
F2 common plane for the second pair of fixing surfaces
F3 common plane for the third pair of fixing surfaces
G1 straight line between plane E1 and base plate plane
G2 straight line between plane E2 and base plate plane
G3 straight line between plane E3 and base plate plane
G1′ straight line between plane F1 and mirror base plane
G2′ straight line between plane F2 and mirror base plane
G3′ straight line between plane F3 and mirror base plane
α acute angle of intersection
β angle between the base plate plane and the respective resistance plane
β′ angle between the mirror base plane and the respective fixing plane

1.-11. (canceled)

12. A base plate for arrangement on a windshield of a vehicle and for accommodating a mirror base for an interior mirror, comprising:
a base plate plane of the base plate;
wherein at least six resistance surfaces are arranged on the base plate plane;
wherein two of the at least six resistance surfaces in each case are arranged at least in part on a common resistance plane, as a result of which three resistance planes are formed;
wherein each of the three resistance planes is aligned with respect to the base plate plane so as to intersect the base plate plane in a straight line, forming at least three straight lines on the base plate plane,
wherein the three straight lines have one point of intersection with one another at least in pairs at an acute angle of intersection (α), as a result of which three acute angles of intersection (α) are formed, the point of intersection is arranged between the associated resistance surfaces of the intersecting straight lines, and the acute angles (α) are equal.

13. The base plate according to claim 12, wherein
six resistance surfaces are arranged on the base plate plane and the acute angles of intersection (α) are each 60°.

14. The base plate according to claim 12, wherein
two resistance surfaces are arranged at least in part in a common resistance plane such that, when the base plate is in an installed state in the vehicle, the two resistance surfaces are configured to absorb an impact force resulting from a collision in the X-direction of the vehicle.

15. The base plate according to claim 12, wherein
the base plate has a side wall, wherein a through-hole for receiving a clip for a tether is arranged in the side wall.

16. The base plate according to claim 15, wherein
an engagement region for engagement of a torsion spring of planar design is formed on the side wall.

17. The base plate according to claim 16, wherein
the engagement region comprises fixing elements projecting from the side wall for the engagement of the torsion spring and at least two recesses, wherein each of the at least two recesses has a pre-fixing rib on the side wall for engaging with the torsion spring.

18. The base plate according to claim 12, wherein
an angle (β) between the base plate plane and a respective resistance plane is less than 90°.

19. The base plate according to claim 18, wherein the angle (β) lies in the range of 25° to 45°.

20. A mirror base for connecting to a base plate and for arranging an interior mirror on a windshield of a motor vehicle, comprising:
a mirror base plane of the mirror base,
wherein at least six fixing surfaces are arranged on the mirror base plane,
wherein two of the at least six fixing surfaces in each case are arranged at least in part on a common fixing plane, as a result of which three fixing planes are formed,
wherein each of the three fixing planes is aligned with respect to the mirror base plane so as to intersect the mirror base plane in a straight line, forming three straight lines on the mirror base plane,
wherein the three straight lines have one point of intersection with one another at least in pairs at an acute angle of intersection (α), as a result of which three acute angles of intersection (α) are formed, the point of intersection is arranged between the associated fixing surfaces of the intersecting straight lines, and the acute angles of intersection (α) are equal.

21. A mounting arrangement for attaching an interior mirror to a vehicle, comprising:
a base plate comprising:
a base plate plane of the base plate; wherein
at least six resistance surfaces are arranged on the base plate plane;
wherein two of the at least six resistance surfaces in each case are arranged at least in part on a common resistance plane, as a result of which three resistance planes are formed;
wherein each of the three resistance planes is aligned with respect to the base plate plane so as to intersect the base plate plane in a straight line, forming at least three straight lines on the base plate plane,
wherein the three straight lines have one point of intersection with one another at least in pairs at an acute angle of intersection (α), as a result of which three acute angles of intersection (α) are formed, the point of intersection is arranged between the associated resistance surfaces of the intersecting straight lines, and the acute angles a are equal;
a mirror base comprising:
a mirror base plane of the mirror base,
wherein at least six fixing surfaces are arranged on the mirror base plane,
wherein two of the at least six fixing surfaces in each case are arranged at least in part on a common fixing plane, as a result of which three fixing planes are formed,
wherein each of the three fixing planes is aligned with respect to the mirror base plane so as to intersect the mirror base plane in a straight line, forming three straight lines on the mirror base plane,
wherein the three straight lines have one point of intersection with one another at least in pairs at an acute angle of intersection (α), as a result of which three acute angles of intersection (α) are formed, the point of intersection is arranged between the associated fixing surfaces of the intersecting straight lines, and the acute angles of intersection (α) are equal;
wherein, in a final mounted state, the base plate and the mirror base are connected to one another such that a resistance surface and a fixing surface lie adjacent to one another.

22. The mounting arrangement according to claim 21, further comprising:
a sensor for positioning on a windshield for a vehicle,
wherein, in the final mounted state, the sensor and the base plate connected to the mirror base are arranged at different locations on the windshield.

23. A vehicle comprising a mounting arrangement according to claim 22.
